(19) United States
(12) Patent Application Publication
(10) Pub. No.: US 2005/0218211 A1
(43) Pub. Date: Oct. 6, 2005

(54) Communication terminal device

(75) Inventors: Yosuke Saso, Tokyo (JP); Toshimitsu Hayashi, Zama (JP); Toru Nagura, Chigasaki (JP); Jun Maeoka, Kawasaki (JP); Hideki Nakamura, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 10/913,419

(22) Filed: Aug. 9, 2004

(30) Foreign Application Priority Data
Mar. 31, 2004 (JP) 2004-102094

(51) Int. Cl. G06K 5/00

(52) U.S. Cl. 235/380

(57) ABSTRACT

Conventionally, obtaining both information regarding use of a credit card and information regarding an account to which credit card payment is debited is not considered. For instance, when paying by credit using a communication terminal device, obtaining information regarding a payment amount and information regarding a bank balance is not considered. Thus, a communication terminal device capable of transmitting/receiving data, comprises: a communication portion transmitting/receiving data; a display portion displaying information received by the communication portion; and a control portion controlling the communication portion and display portion, wherein the communication portion receives card use information from a server of a card company and account information from a server of a financial institution; and wherein the control portion operates to display the card use information and the account information side-by-side on the display portion.

### BACKGROUND OF THE INVENTION

The present invention relates to a communication terminal device, particularly to a communication terminal device capable of obtaining information regarding credit card use as well as information regarding an account in a financial institution.

There has been proposed a technique where a communication terminal device is connected to a terminal of a financial institution through a network so that account inquiry procedures are carried out at the terminal of the financial institution in response to a request for an account inquiry from the communication terminal device, the result of which inquiry is transmitted to the communication terminal device. Such a technique is disclosed in JP-A-2003-271818, for instance.

However, the above-described conventional technique only teaches to inquire the balance of the account in the financial institution, and does not teach to obtain both information regarding credit card use and information regarding the account.

For instance, when a user of a communication terminal device makes a payment by a credit card with using the device, it is convenient for the user if information regarding use of the credit card to date (e.g., information indicative of the amount which has been paid by the credit card) and information regarding an account in a financial institution to which the payment is debited, (e.g., information indicative of a bank balance), are both available, since in such a case the user can decide whether to use the credit card by taking the bank balance into consideration, when the user is going to make a payment. However, such an arrangement is not disclosed in the above-indicated publication.

It is also convenient for the user if the result of a comparison between the amount which has been paid by the credit card and the bank balance is displayed, since this arrangement is effective to prevent excessive use of credit. The above-indicated publication does not disclose this arrangement, also.

An object of the present invention is to provide a communication terminal device which is highly convenient, solving the above-described problems.

### SUMMARY OF THE INVENTION

To attain the above object, this invention provides a communication terminal device capable of transmitting and receiving data, the communication terminal device comprising: a communication portion which transmits and receives data; a display portion which displays information received by the communication portion; a control portion which controls the communication portion and the display portion, wherein the communication portion receives card use information from a server of a card company and account information from a server of a financial institution, and wherein the control portion operates to display the card use information and the account information side-by-side on the display portion.

According to the invention, a communication terminal device which is highly convenient can be provided.

### BRIEF DESCRIPTION OF THE DRAWINGS

FIG. 1 is a block diagram of a balance inquiry system.

FIG. 2 is a block diagram showing one example of the overall structure of a mobile terminal according to the invention

FIG. 3 is a flowchart illustrating a processing for obtaining and displaying information which involves authentication information.

FIG. 4 shows an example of displaying a notification to a user, in the balance inquiry system.

FIG. 5 is a flowchart illustrating a credit card payment processing performed in the system.

FIG. 6 is a flowchart illustrating a processing for obtaining and displaying information upon a payment using the mobile terminal, including the credit card payment processing of FIG. 5.

FIG. 7 is a flowchart illustrating a user authentication processing included in the processing shown in FIG. 6.

FIG. 8 is a flowchart illustrating a withdrawability notifying processing implemented in the system.

FIG. 9 shows an example of a screen display presented in a case where it is determined that a payment can be withdrawn from an account, in the processing of FIG. 8.

FIG. 10 shows an example of a screen display presented in the other case where it is determined that a payment can not be withdrawn from an account.

FIG. 11 is a flowchart illustrating a credit limit setting processing.

FIG. 12 shows an example of a screen display presented in a case where an amount of credit card payment exceeds the credit limit.

FIG. 13 is a block diagram of a balance inquiry system where a plurality of card companies having respective systems is involved.

FIG. 14 is a flowchart illustrating a processing for obtaining card use information from the plurality of card companies.

FIG. 15 shows a screen display indicating the card use information and historical information related to account balance information.

FIG. 16 is a flowchart illustrating a processing for displaying a result of a comparison made between a total amount debited to, or to be withdrawn, from an account and the current balance of the account.

FIG. 17 shows an example of a screen display indicating the result of the comparison.

FIG. 18 shows a table on credit cards.

FIG. 19 shows a table on accounts debited.

### DESCRIPTION OF THE PREFERRED EMBODIMENTS

There will be described in detail several embodiments of the present invention, with reference to the accompanying drawings.

<First Embodiment>

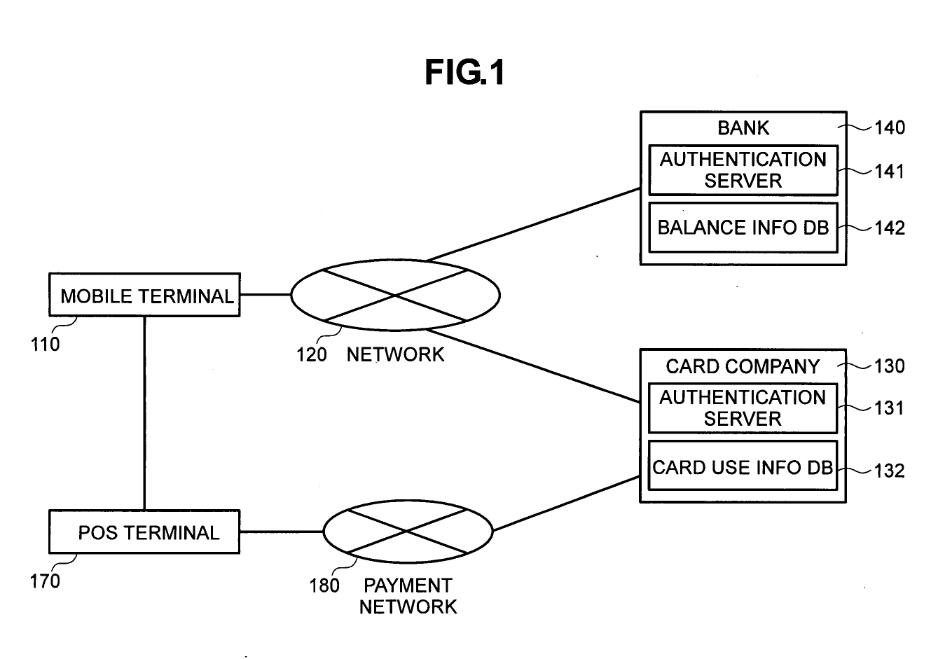

FIG. 1 is a block diagram of a balance inquiry system. As shown in FIG. 1, the balance inquiry system is constructed such that a mobile terminal 110, a card company system 130, and a bank system 140 are connected to a network 120. To the card company system 130 are connected an authentication server 131 and card use information database (DB) 132, while an authentication server 141 and a balance information database (DB) 142 are connected to the bank system 140. Further, a POS terminal 170 and the card company system 130 are connected to a payment network 180.

More specifically, where the mobile terminal 110 is equipped with a function of making a payment by a credit card, the mobile terminal 110 requests, after making a payment by a credit card, card use information from the card company system 130, and information indicative of the balance of an account debited for the payment from the bank system 140. The mobile terminal 110 is capable of obtaining information accumulated in the card use information DB 132 and balance information DB 142, respectively, and the obtained information is displayed on a main display portion 260 and/or others. A payment by a credit card with using the mobile terminal 110 may be implemented such that the mobile terminal 110 sends the POS terminal 170 information related to the credit card such as the credit card number, and/or merchandise information such as the price and/or the name of the article purchased, via an infrared link or otherwise. Then, the POS terminal 170 forwards the information received from the mobile terminal 110 to the card company system 130 through the payment network 180.

The mobile terminal 110 obtains necessary merchandise information by (i) reading a barcode attached to the article with a barcode reading portion (not shown) of the mobile terminal 110, (ii) reading an IC tag attached to the article with a tag reading portion (not shown) of the mobile terminal 110, or (iii) the user keying-in the necessary information. The mobile terminal 110 is capable of making a communication with the POS terminal 170 through a POS communication portion 281 incorporated in the mobile terminal 110. The POS communication portion 281 communicates with the POS terminal 170 via an infrared link, a short-range wireless link such as that of Bluetooth, or a cable.

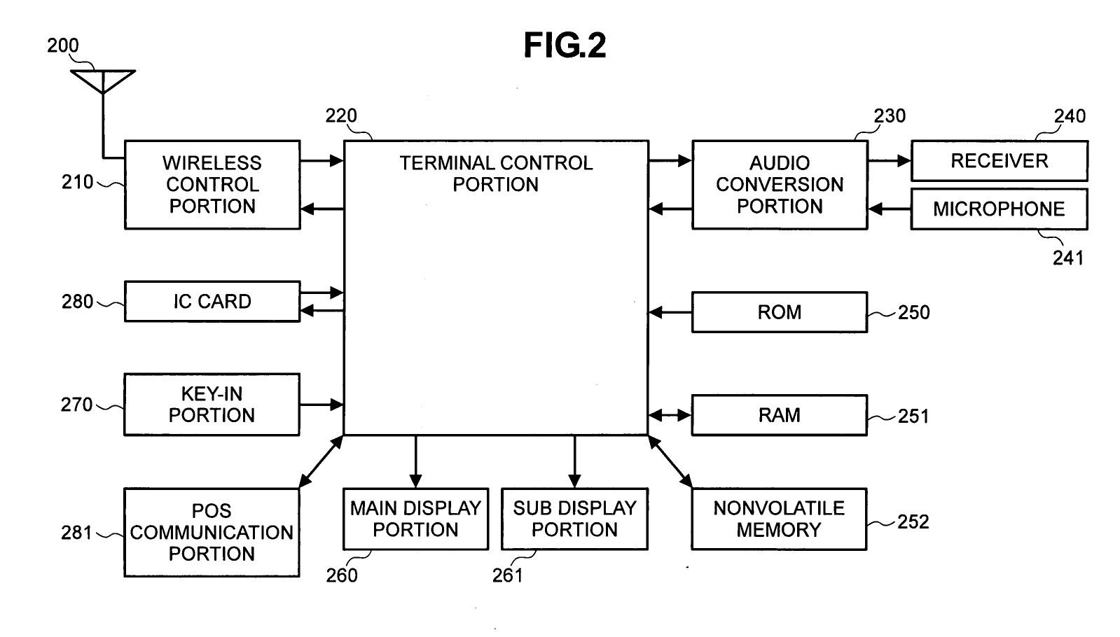

FIG. 2 is a diagram showing the overall structure of the mobile terminal 110 according to the invention.

The mobile terminal 110 comprises: a wireless antenna portion 200; a wireless control portion 210; a terminal control portion 220; an audio conversion portion 230; a receiver 240; a microphone 241; a ROM 250; a RAM 251; a nonvolatile memory 252; a main display portion 260; a sub display portion 261; a key-in portion 270; an IC card 280; and the POS communication portion 281.

The wireless antenna portion 200 comprises an antenna for transmitting/receiving data to/from a wireless base station by radio. The wireless control portion 210 performs processings for receiving/transmitting data from/to the wireless antenna portion 200, as well as all AD/DA data conversion processings. The terminal control portion 220 sequentially reads out programs stored in the ROM 250 and, based on the instructions contained in the programs, controls communications and audio, and operations of the key-in portion, the main display portion, the sub display portion, and the mobile terminal 110 as a whole. The audio conversion portion 230 performs analog-digital and digital-analog conversions of audio data. The nonvolatile memory 252 can hold the memorized contents even after the mobile terminal 110 is powered off, and is thereby capable of storing a credit limit which is the maximum amount the user is allowed to pay by the relevant credit card and which has been set by the user him/herself, and historical information related to the amount of payment which has been made by the credit card (which amount may be referred to as “credit payment amount” hereinafter).

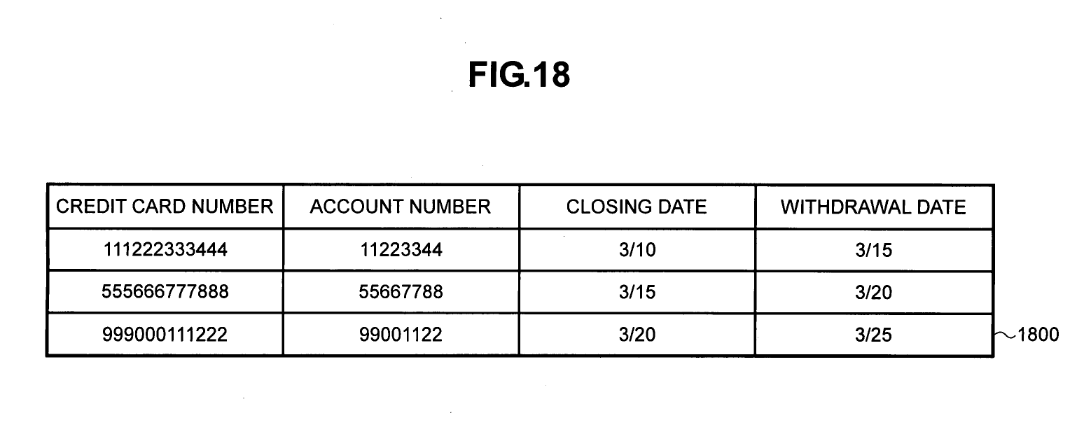

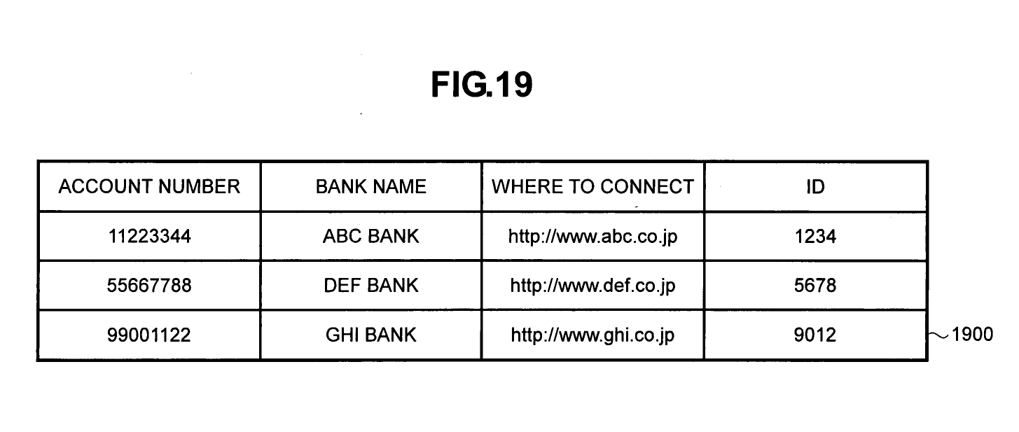

The IC card 280 is detachable from the mobile terminal 110 and stores information regarding one or more credit card and information regarding one or more financial institution or bank. For instance, the IC card 280 stores a table on credit cards such as an example 1800 shown in FIG. 18 and a table on accounts such as an example 1900 shown in FIG. 19. These tables are referred to as needed The IC card 280 further stores a password which is required when utilizing a lock function for preventing an unauthorized use of the balance inquiry system by a third party.

FIG. 18 shows a table related to credit cards, which contains information regarding each credit card such as credit card number, number of the account debited for payment by the credit card, closing date, and withdrawal date or deduction date. Such information may be registered by the user, or may be retrieved from dedicated terminals or the like for the respective credit cards. FIG. 19 shows a table related to debited accounts, which contains information regarding each financial institution account or bank account, such as account number, bank name, network location or URL, and ID.

Each of the main and sub display portions 260, 261 is a display screen for indicating necessary information, and may be a liquid crystal display screen. These display portions 260, 261 display the information regarding the credit card and information regarding the financial institution account or bank account, and a result of a comparison made between these two kinds of information.

There will now be described a flow of data through the balance inquiry system. Data received through the antenna portion 200 and wireless control portion 210 is read by the terminal control portion 220, accumulated in the RAM 251, and displayed on the main or sub display portion 260, 261 in accordance with an instruction input by the user. On the other hand, data for transmission as prepared with using the key-in portion 270 or others is read out from the RAM 251, and forwarded to the network 120 through the terminal control portion 220, wireless control portion 210 and antenna portion 200.

There will be now described a data flow in transmitting/receiving audio data, in a case where the mobile terminal 110 is a mobile phone. Audio data received through the antenna portion 200 and wireless control portion 210 is converted into an analog format by operations of the terminal control portion 220 and audio conversion portion 230, and is sent to the receiver 240 to be played there. On the other hand, analog audio data or voice from the user is input through the microphone 241 and converted into digital data by the audio conversion portion 230. The digital data is properly encoded by operations of the terminal control portion 220, wireless control portion 210 and antenna portion 200 of the mobile phone, and then forwarded to a base station in the mobile phone network.

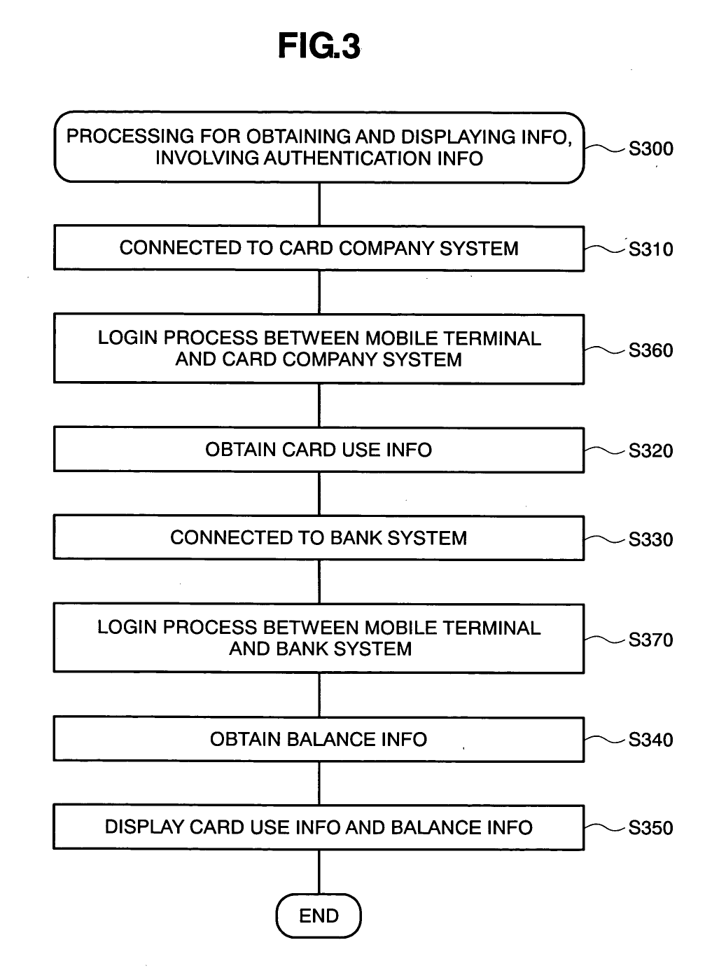

FIG. 3 is a flowchart illustrating a processing S300 for obtaining and displaying information, involving authentication information. In the processing S300, the card use information and balance information is obtained from the card company system 130 and bank system 140, respectively, with using the mobile terminal 110, and is displayed on the main display portion 260 of the mobile terminal 110, for instance.

More specifically, the mobile terminal 110 is connected to the card company system 130 (S310) to obtain the card use information stored in the card use information DB 132 (S320). Thereafter, the mobile terminal 110 is connected to the bank system 140 (S330) to obtain the balance information stored in the balance information DB 142 (S340). When the mobile terminal 110 is connected to the card company system 130, a login process therebetween is implemented (S360); and when the terminal 110 is connected to the bank system 140, a login process therebetween is implemented (S370). In each step S360, S370, the card company system 130 or bank system 140 respectively uses a user ID. As the user ID, the card company system 130 employs information such as the credit card number unique to the user's credit card and the expiration date of the card while the bank system employs the account number unique to the user's account. The mobile terminal 110 notifies the user of the card use information and balance information as obtained, by displaying the two kinds of information on the main display portion 260 or others (S350).

It is noted that although in the present embodiment the card use information is initially obtained and subsequently the balance information is obtained, this order may be reversed. Further, the obtaining the card use information and balance information may be implemented at any timing as desired by the user. Since once the information is obtained the information can be stored in the nonvolatile memory 252 of the mobile terminal 110, the user can see the previously obtained information regardless of time and place. Further, it may be arranged such that the IC card 280 stores the card use information and account information; in this case, obtaining the card use information and balance information related to the user with a mobile terminal owned by a third party is enabled by inserting the IC card 280 into the third party's mobile terminal. Thus, even when the user does not carry his/her own mobile terminal, the two kinds of information can be obtained.

Where the mobile terminal 110 has the function of making a payment by a credit card, the mobile terminal 110 automatically requests the card use information from the card company system 130 and the balance information from the bank system 140, at the point of time when a payment by a credit card is complete, and both the kinds of information as obtained are displayed on the main display portion 260 or others at a time, to be notified to the user. The user can thereby see the card use information and the balance in the bank account immediately after each credit card payment is complete, which contributes to effectively prevent abuse of the credit card. For instance, where the user purchases a number of articles by making a stop at numerous shops, each time the user purchases an article, the above-described two kinds of information are displayed, so that the abuse of the credit card is effectively prevented and at the same time the convenience of the user is enhanced since the user can check the bank balance each time he/she has made a payment which is to be debited from the bank account. If these kinds of information are not displayed, the user may inadvertently abuse the credit card. According to the present invention, such a problem can be avoided.

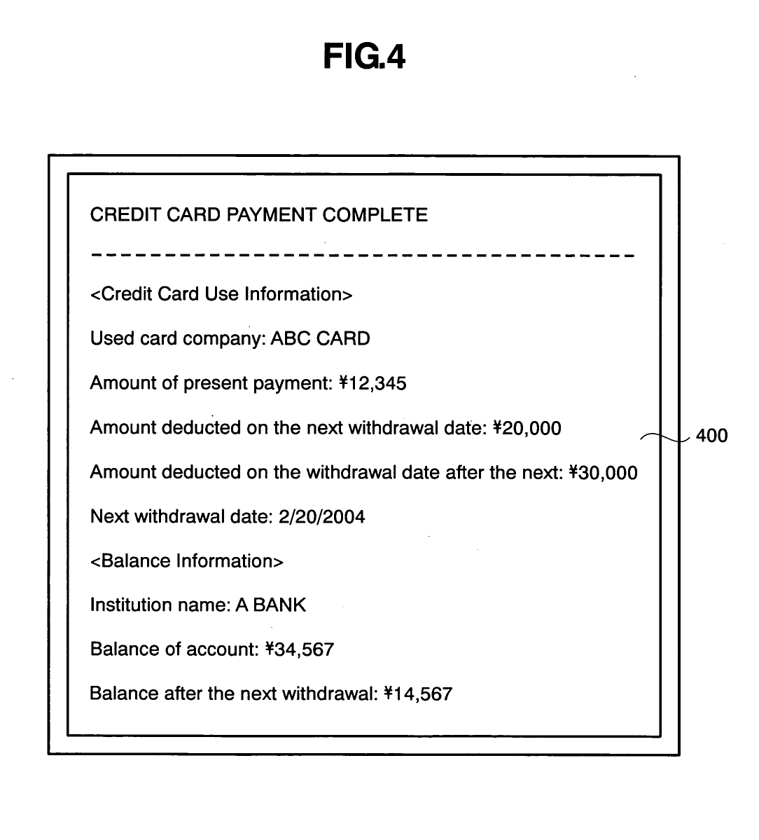

In FIG. 4 is shown an example 400 of a display presented on the main display portion 260 for notifying the user of the above-described two kinds of information. A screen example 400 of FIG. 4 is presented on the main display portion 260 upon completion of a credit card payment using the mobile terminal 110. As seen in FIG. 4, the screen example 400 shows: the name of the used card company, amount of credit card payment which has been made just now, amount to be deducted from the account on the next withdrawal date, amount to be deducted from the account on the withdrawal date after the next, the next withdrawal date, etc., as the card use information. The screen example 400 further shows: the name of the bank, amount of the balance, balance after the withdrawal on the next withdrawal date, etc., as the balance information. The user can thereby see the various information, depending on which the user decides whether to use the credit card or not. For instance, it is made possible for the user to restrain him/herself from further using the credit card where the credit payment amount is large or where the bank balance is low. Further, since it is arranged such that the bank balance in association with each credit card is displayed, where the balance of a bank account is low, the user can choose to use another credit card with which another bank account is associated (that is, payment made by the another credit card is debited to the another bank account).

The displaying or notification of the information may be implemented at various timings and frequencies, e.g., every time and immediately after a credit card payment is complete, the previous day of the deduction from the account with respect to payment made by the credit card, or periodically once every day. The user can thereby check the various information with a certain periodicity. For example, where the notification to the user is implemented immediately after a payment by a credit card is complete, the user can see, just after the credit card payment is made, the credit payment amount with respect to the credit card used just now and the balance of the associated account. This facilitates having the current relationship between the credit payment amount and the balance of the account.

FIG. 5 illustrates a credit card payment processing (S500) performed when the user makes a payment using the POS terminal 170 or others. When making a payment by the credit card with using the POS terminal 170, the user first activates the function of making a payment by a credit card as installed in the mobile terminal 110 (S510). Then, credit information is forwarded (S520); more specifically, in response to a settlement request from the POS terminal 170, the information regarding the credit card such as the credit card number, expiration date, etc. is read out from the IC card 280, and is sent to the POS terminal 170. The credit card information received by the POS terminal 170 is then forwarded to the card company system 130 through the payment network 180. The payment procedures taken between the POS terminal 170 and the card company system 130 is well known in the art and is not illustrated here. It is noted that although the credit card information such as the credit card number, expiration date, etc. is sent from the mobile terminal 110 to the POS terminal 170 in steps S520, the merchandise information such as the price and the name of the article purchased may be sent in this step.

The IC card 280, nonvolatile memory 252 and others stores the credit card number, expiration date, etc. By this arrangement, where a credit card payment is made while the IC card 280 is inserted in the mobile terminal 110, the user need not bother to input the credit number, expiration date, etc. to make the credit card payment, enhancing the convenience of the user.

Further, information indicative of the date on which the credit card payment is made is stored in association with the amount of the credit card payment. This is because a credit card payment system is constructed such that the closing date and the withdrawal date of the billing cycle of the payment system are set independently. More specifically, it is typical that the billing cycle of a credit card payment system is a month; and where the closing date and the withdrawal date of the payment system are different, there is a possibility that the user can not exactly calculate the amount of credit card payment for each month.

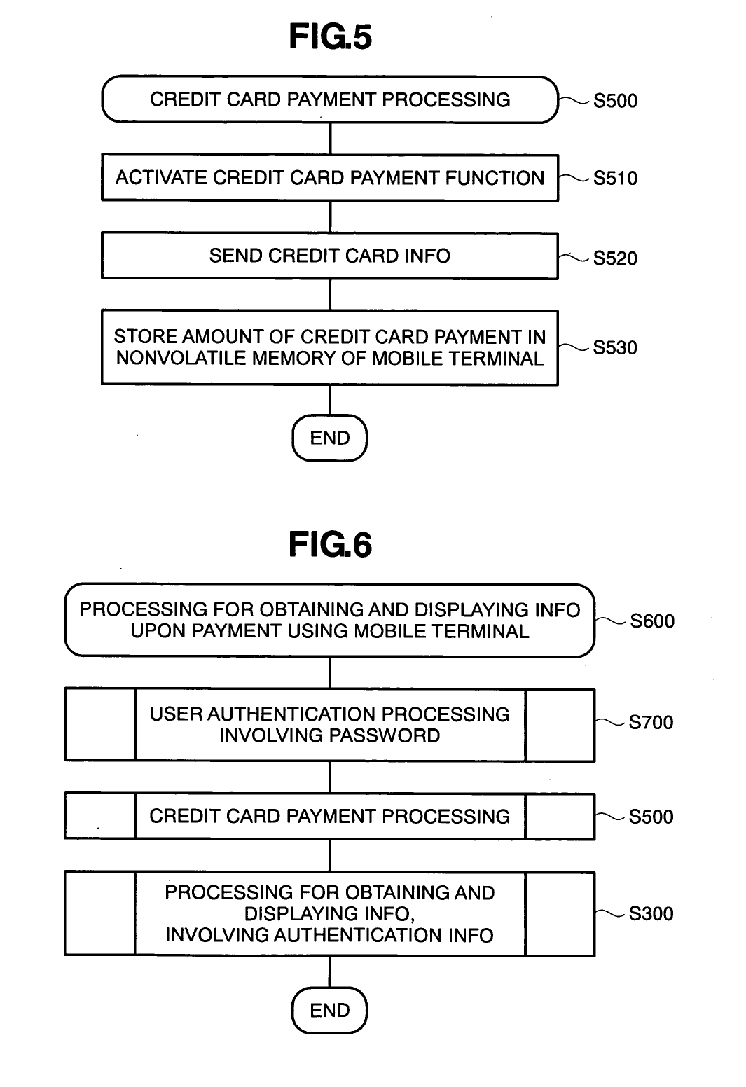

FIG. 6 illustrates a processing (S600) for obtaining and displaying information upon a credit card payment using the mobile terminal, in a case where the lock function is introduced. A user authentication processing (S700) involving a password is implemented to prevent a third party from obtaining the card use information and balance information by spoofing. The term “password” refers to a password required to be input into the mobile terminal 110 when a credit card payment is to be made using the terminal 110, and has been stored or set in the IC card 280 by the registered user in advance. After the user authentication processing, above-described steps S500, S300 are implemented and the obtained information is displayed.

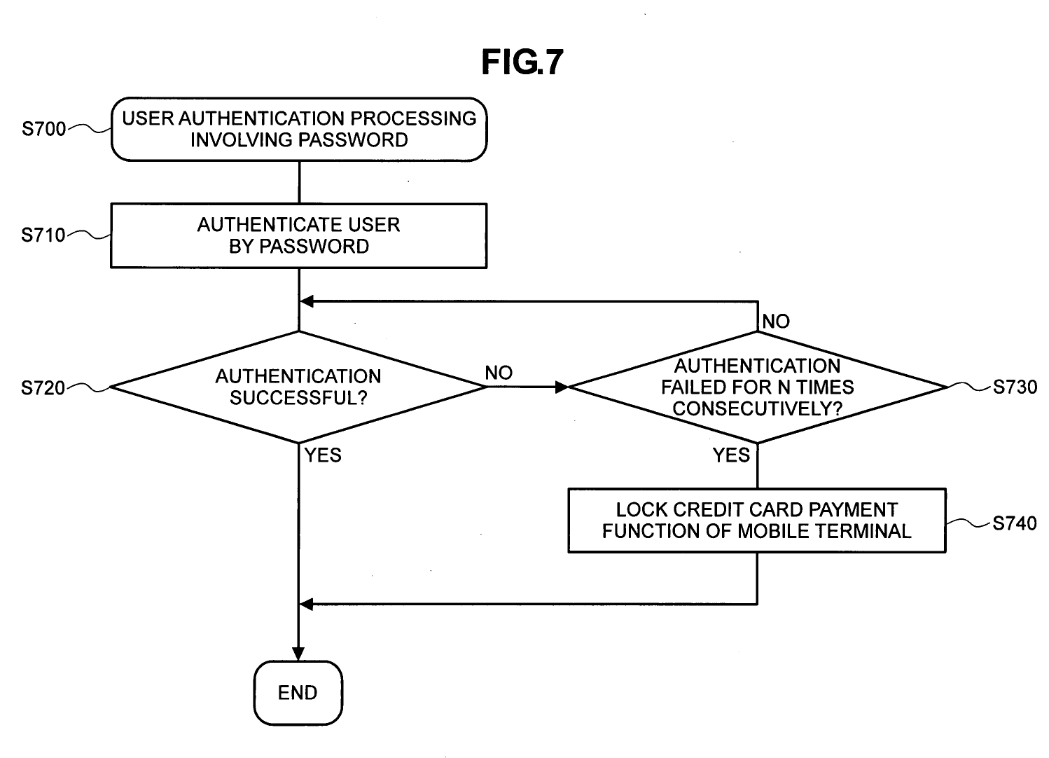

FIG. 7 illustrates the user authentication processing (S700) involving the password. A user authentication is performed (S710) using a password or others. Where the authentication does not succeed (S720), reentering the password or others is allowed for n-1 times. Where the authentication fails for n times (S730), the lock function is activated so as to prevent use of the credit card by the third party (S740). Once the lock function is activated, there is taken a measure such that no more manipulation is accepted, for instance, so as to prevent the third party from obtaining by spoofing the card use information and balance information with using the mobile terminal 110.

With the IC card 280 being equipped with such a lock function, it is necessary to insert the IC card 280 owned by the registered user as well as input the valid password, when to obtain the card use information and balance information. This effectively enhances the security of the balance inquiry system. In the conventional balance inquiry system where a password is typed in on the browser, for instance, the password and others are held by the browser, and therefore it can not be said that such a system is sufficiently secure. On the other hand, according to the present invention where the password stored in the IC card 280 is used in the user authentication processing (S710), the password is not held by the browser. In addition, the lock function is activated (S740) when the process of the password input is not normally performed. Thus, the security of the balance inquiry system is enhanced.

<Second Embodiment>

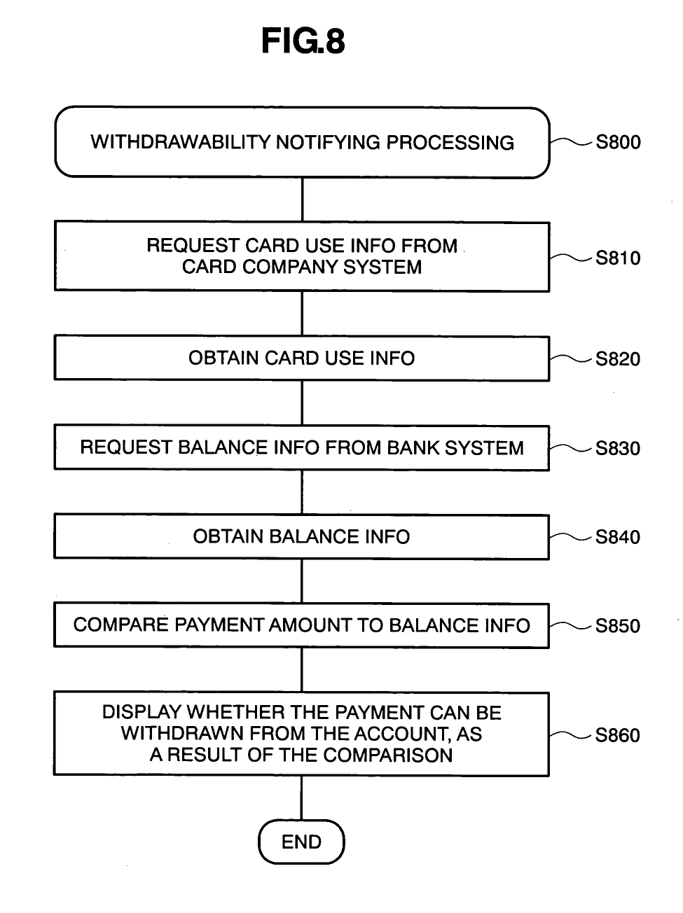

FIG. 8 illustrates a withdrawability notifying processing (S800) implemented in the mobile terminal 110 to notify the user of whether a withdrawal is possible or not prior to the relevant withdrawal date. The user can freely configure the notifying processing as to a reference date necessary to make the determination on whether a withdrawal is possible, which reference date may be set at the withdrawal date or closing date of the cycle of the billing system of the relevant card company. Further, the date on which the notification is made may be set at a date preceding the withdrawal date by a desired number of days. As the timing of making the notification, there may be selected the day before the withdrawal date, every day, or immediately after a credit card payment is made using the mobile terminal 110, for instance.

On the date set as the notification date the mobile terminal 110 connects itself to the card company system 130 to request the card use information (S810), and obtains the card use information from the card use information DB 132 (S820). Then, the mobile terminal 110 connects itself to the bank system 140 to request the balance information (S830) and obtains the balance information from the balance information DB 142 (S840). Subsequently, there is made a comparison (S850) between the amount of the payment debited just now to the relevant account and the balance information, and the result of the comparison, or a determination on whether the withdrawal of the amount from the account is possible or not in view of the current balance, is displayed on the main display portion 260 or others (S860).

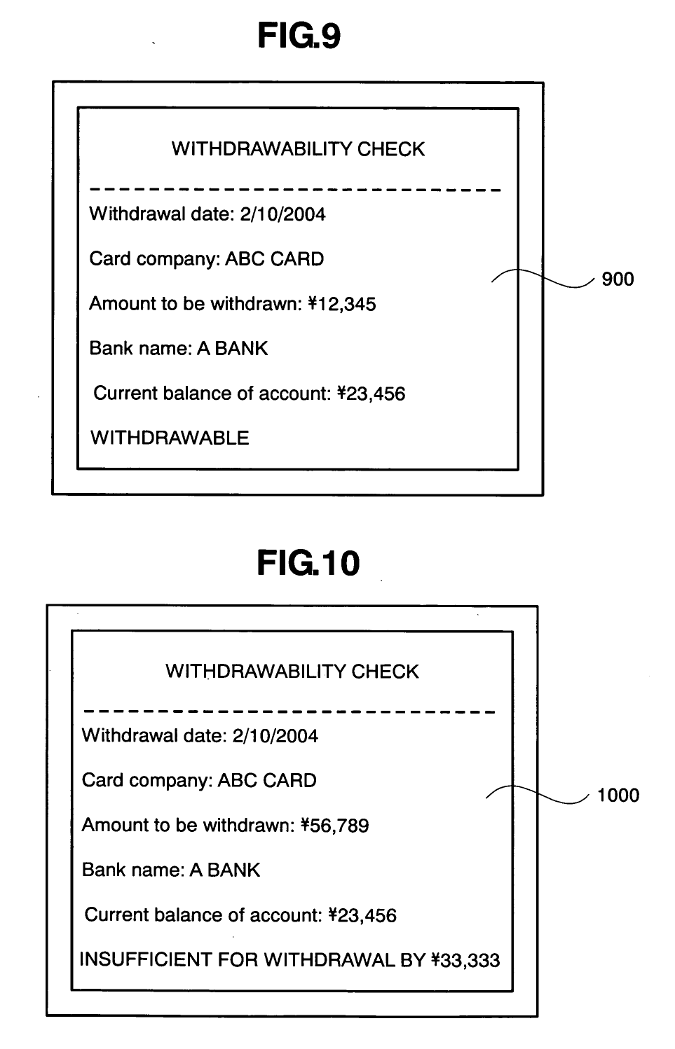

Examples of a screen display for notifying the user of the result of the comparison or determination are shown in FIGS. 9 and 10; an example 900 of the screen display shown in FIG. 9 is presented when it is determined that the payment can be withdrawn from the account, while another example 1000 of the screen display shown in FIG. 10 is presented when it is determined that the payment can not be withdrawn from the account. The example 900 of the screen display indicates the withdrawal date, payment amount, current balance, result of the comparison made in step S850 between the payment amount and the balance information, etc.

The example 1000 of the screen display is presented when it is determined based on the comparison made in step S850 that the payment amount can not be withdrawn from the account. The example 1000 indicates information similar to that indicated in the display screen example 900, and in the case where the payment amount can not be withdraw from the account, an amount insufficient to be withdrawn or the like is also indicated to alert the user to the shortage of the balance of the account. Further, the user may be notified of the withdrawability in a manner other than such a display on the main display portion 260 or others. For instance, a nonvisual notification such as a notification by sound or vibration may be made. By this arrangement, the abuse of credit card can be effectively prevented.

More specifically, when a credit card payment is made, it is typical that the user is notified of the fact that the withdrawal from the user's account for the payment is to be made by mail or otherwise, several days before the withdrawal date. In such a case, however, the user may not open the mail inadvertently, or may open the mail but fail to deposit funds into the account, thereby making the withdrawal from the account impossible. According to the preset invention, on the other hand, where a payment to be withdrawn from an account is larger than the balance of the account, a notification indicating the fact is made to the user through the mobile terminal 110, thereby enabling the user to know without fail that the balance is insufficient. In addition, the system according to the invention can be configured to make the notification, for instance, on the day before the withdrawal date, every day during the balance is insufficient, or all the time, so s to prompt the user to deposit funds to compensate for the insufficiency of the balance.

<Third Embodiment>

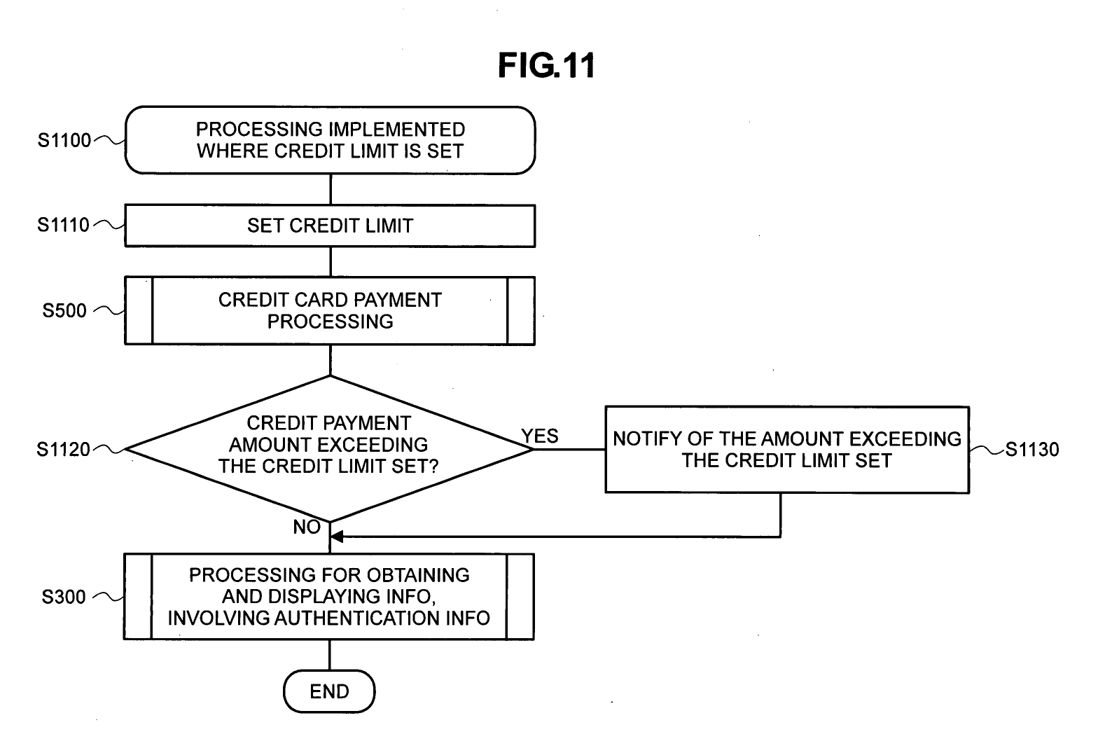

FIG. 11 a processing S1100 implemented using the mobile terminal 110 where a credit limit is set. This processing is for notifying the user, upon making a credit card payment, of the fact that a preset limit of credit card payment is exceeded, when appropriate. More specifically, to prevent abuse of a credit card by the user due to the easy accessibility to the credit function installed in the mobile terminal 110, it is arranged such that the user can set in the mobile terminal 110 a limit to an amount of payment which can be made by a credit card during a time period, so that the mobile terminal 110 notifies the user of the fact that the user is about to make a credit card payment over the set limit, when appropriate.

First, the user sets the credit limit in the nonvolatile memory portion 252 of the mobile terminal 110 or other locations (S1210). Then, the credit card payment processing S500 is implemented using the mobile terminal 110. The preset credit limit and the credit payment amount which has been made to date are compared to each other (S1120). Where the credit payment amount exceeds the credit limit, this fact is displayed on the screen of the mobile terminal or otherwise notified to the user (S1130), and then the processing S300 for obtaining and displaying information is implemented.

In step S1120 to compare the credit payment amount with the preset credit limit, the credit payment amount to date as stored in the nonvolatile memory 252 is compared to the credit limit set by the user in advance in the nonvolatile memory portion 252 or other locations in step S1110. The entirety of step S1120 is performed in the mobile terminal 110.

In step S1130, it is notified to the user whether the credit payment amount exceeds the credit limit preset by the user. In a case where it is determined in step S1120 that the credit payment amount exceeds the credit limit, the fact is notified to the user, for instance, in such a manner that the main display portion 260 indicates this fact. The user may be notified that the user is about to make a credit payment over the credit limit, in a manner other than the display on the main display portion 260; for example, a nonvisual notification such as a notification by sound or vibration may be made.

In the present embodiment, the processing (S1120) of comparing the credit payment amount with the credit limit preset by the user is implemented after the completion of the credit card payment processing (S500), as shown in FIG. 11. However, the credit card payment processing S500 may be implemented after step S1120. Where step S500 is implemented after step S1120, the amount of the payment input by the user is first stored in the nonvolatile memory portion 252 of the mobile terminal 110, before the amount of the payment is transmitted to the POS terminal. Then, the credit limit set by the user and stored in advance in the nonvolatile memory portion 252 is compared to the amount of the present credit payment. Where the credit limit is to be exceeded, this fact is notified to the user. It may be configured such that where the user who now knows the result of the comparison nonetheless approves the payment, the credit card payment processing (S500) is implemented. According to this arrangement, a credit card payment with enhanced flexibility is enabled.

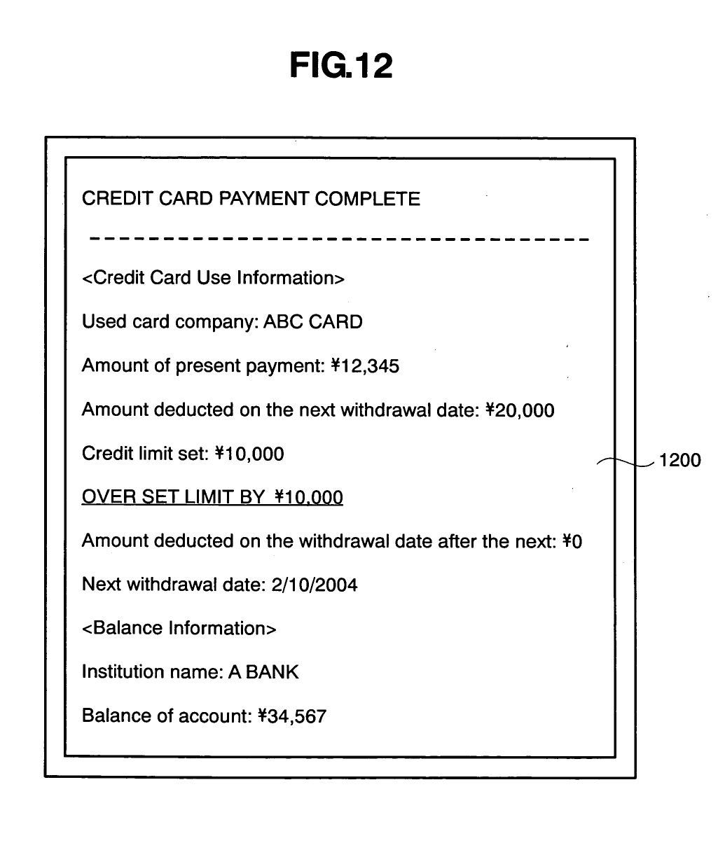

In step S530, the credit payment amount is stored in the nonvolatile memory portion 252 of the mobile terminal 110, in the above description. However, the credit payment amount may be stored in the IC card 280, instead. Alternatively, the credit payment amount may be obtained such that the mobile terminal 110 is connected to the card company system 130 to access the card use information DB 132 therein from which the credit payment amount to date is retrieved. According to this arrangement, historical information related to the user's previous card use can be referred to.

Where the card use information is stored in the IC card 280, even when to make a payment using a mobile terminal owned by a person other than the user, there is no need to set up various parameters related to the processings in the balance inquiry system once again, as long as the IC card 280, configurations in which are valid in the processings, is inserted in the mobile terminal. Further, since in such a case the credit card payment amount is also stored in the user's IC card 280, the user convenience is enhanced.

Where the credit card payment amount exceeds the credit limit, a screen display 1200 shown in FIG. 12 is presented, for instance. That is, the example 1200 of the screen display is presented when the user has made a payment by the credit card over the credit limit as set in the mobile terminal 110. In the example 1200 of the screen display, there are indicated, for instance, the preset credit limit and an amount by which the credit limit is exceeded, so as to make the user realize that the user has made a payment over the preset credit limit.

Because of its nature, the method of credit payment conventionally has a negative aspect that the user may not be sufficiently aware that he/she is making a payment, leading to the user unknowingly abusing credit cards. According to the present invention, when a payment over the credit limit preset by the user is made, or, is about to be made, the mobile terminal 110 notifies the user that he/she is using a credit card more than he/she has initially intended to.

The timing of this notification may be selected among from: immediately after a payment which makes the total amount of credit payment over the credit limit; when the total amount of credit payment reaches a specific proportion (e.g., 80% or 50%) of the credit limit; every day from the point of time when the credit limit is exceeded; and all the time after the credit limit has been exceeded (in which case, the notification is kept displayed on the main display portion 260 or others). The user may be notified that the user makes or is about to make a credit payment over the credit limit, in a manner other than the display on the main display portion 260; for example, a nonvisual notification such as that by sound or vibration may be made. Thus, the user can freely set up the timing of the notification, the way of the notification, and the sorts of information regarding credit payment amount which are notified. By setting these factors depending upon the situations, the user can enjoy a significantly high convenience. And such an arrangement is provided because the information regarding the credit payment amount to be notified is expected to vary from user to user, and a mobile terminal is desired to meet the demand of each user.

<Fourth Embodiment>

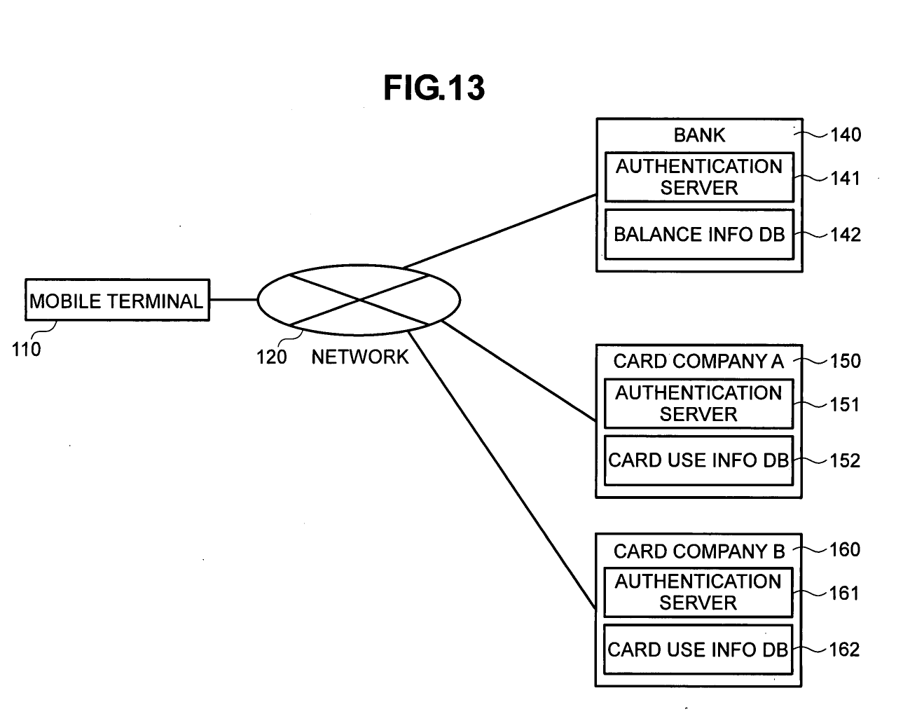

FIG. 13 shows a block diagram corresponding to FIG. 1, but the card company system 130 consists of a plurality of systems. That is, the balance inquiry system shown in FIG. 13 involves a plurality of card companies, namely, card company A and card company B. A system 150 of the card company A and a system 160 of the card company 160 are connected to the mobile terminal 110 when needed via a network 120. The system 150 of the card company A is connected to an authentication server 151 and a card use information DB 152, while the system 160 of the card company B is connected to an authentication server 161 and a card use information DB 162.

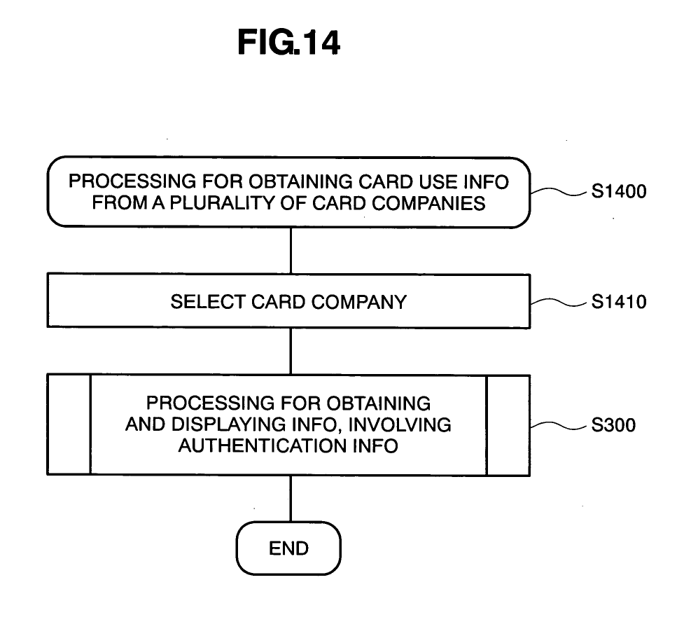

FIG. 14 illustrates a processing S1400 for obtaining card use information from a plurality of companies A, B. In a case where a user has entered into a contract with a plurality of card companies and accordingly there is a plurality of card use information to be referred to, a step S1410 of selecting a card company is implemented. Once a card company to be used has been selected, the processing S300 for obtaining and displaying information is performed, in a way similar to the first embodiment. According to this arrangement, the user can obtain card use information from a desired card company, and obtain balance information from a system of a bank holding the account to which payment made by the credit card issued by the card company is debited.

When card use information is obtained from a plurality of card companies, the obtained information may be stored in a storage area such as the nonvolatile memory portion 252 or IC card 280, so that the user can view such information in the form of a table or otherwise, at any time. This arrangement enables the user to easily see the card use information related to the respective card companies, enhancing the convenience of the user. Further, to have the card use information without accessing the card company or others is enabled, effectively reducing the communication charges billed to the user.

In addition, where a company supplying water, electricity, gas, or others is equipped with a system similar to that of the card company B, the amount of the billed charges can be obtained from the system and compared with the balance in the debited account so as to notify the user of the withdrawability, similarly to where the withdrawal amount is obtained from the system of the card company.

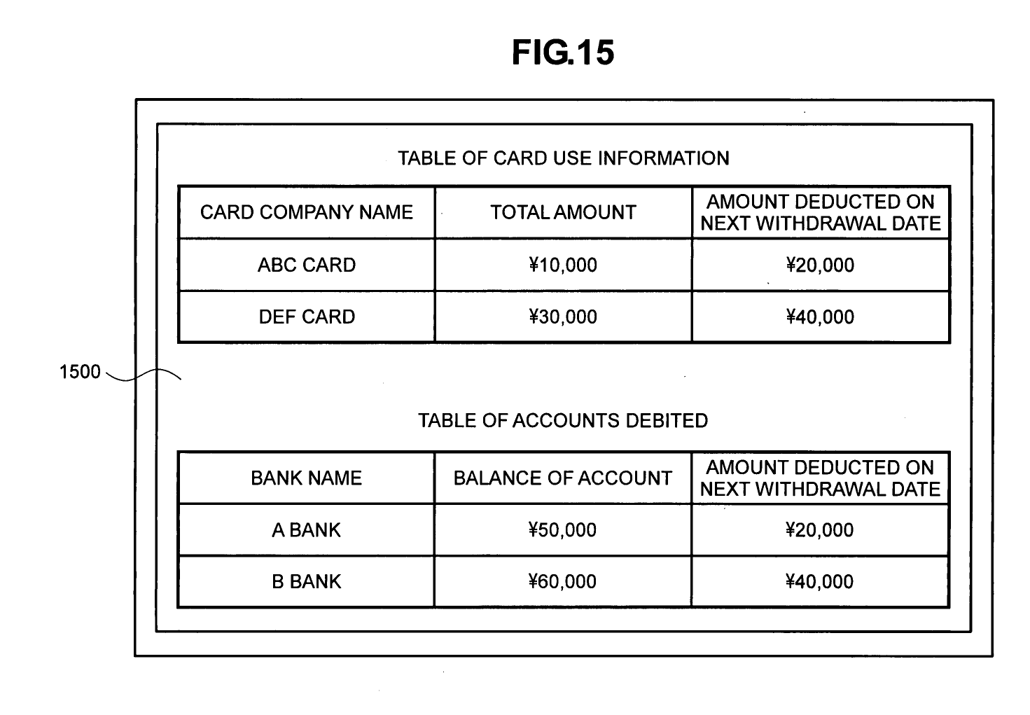

A display screen such as example 1500 shown in FIG. 15 is presented when the user refers to the card use information and balance information which have been previously obtained and stored in the storage area such as the nonvolatile memory portion 252 of the mobile terminal 110 or the IC card 280. The two kinds of information are displayed in a manner to enable the user to instantly cognize the card payment amount and the amount to be withdrawn from the relevant account. In this regard, if balance information is also displayed, a relationship between a withdrawal amount and a balance of an account from which the withdrawal amount is deducted can be notified to the user simultaneously. Therefore, there may be also displayed a relationship between a card company and a balance of an account to which payment made by the credit card issued by the card company is debited, as in the example 1500. According to this arrangement, the user can easily see the card use information and the bank balance, and thus the convenience of the user is enhanced.

<Fifth Embodiment>

As described above with respect to the fourth embodiment, the user may have entered into a contract with a plurality of credit card companies. There is demanded an arrangement enabling the user, even where a plurality of card companies are used, to obtain card use information by a simple operation similar to that in the case where the user uses a single card company. In addition, in the case where a plurality of card companies is used, the user faces difficulty in managing information related to use of the credit cards. Therefore, the mobile terminal 110 according to a fifth embodiment of the invention is equipped with a function of managing and displaying the information obtained from the card companies and financial institutions facilitates the management of the information related to credit card use. Although in the preceding sentence the term “plurality of card companies” is used, information regarding a withdrawal amount for a payment made for any kind of services rendered by a company or institution other than card companies (e.g., electricity, gas or water charges) may be obtained from the relevant company or institution to be compared with the bank balance, so that the result of the comparison is notified to the user, in a similar way as in the case of the card use information.

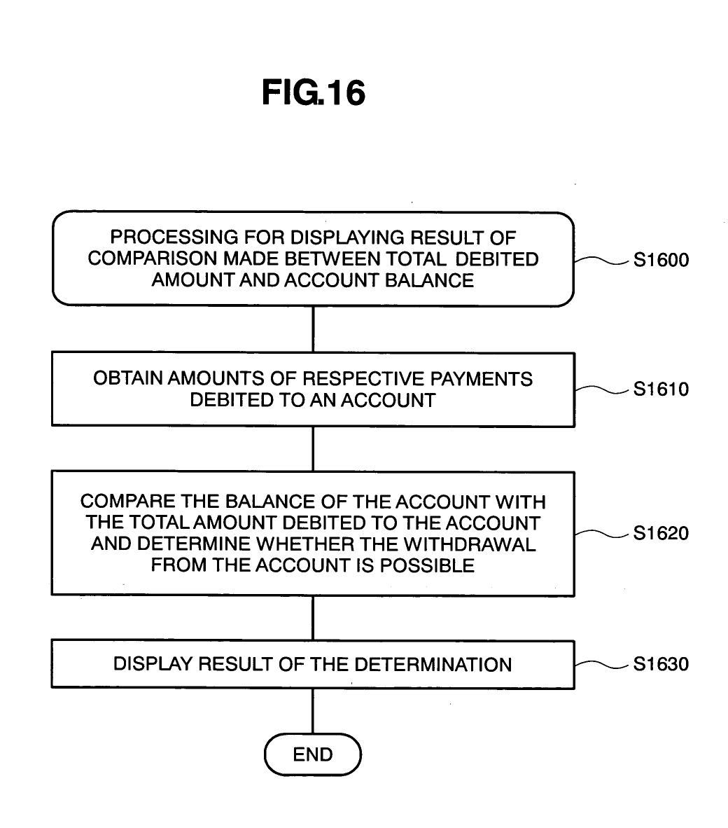

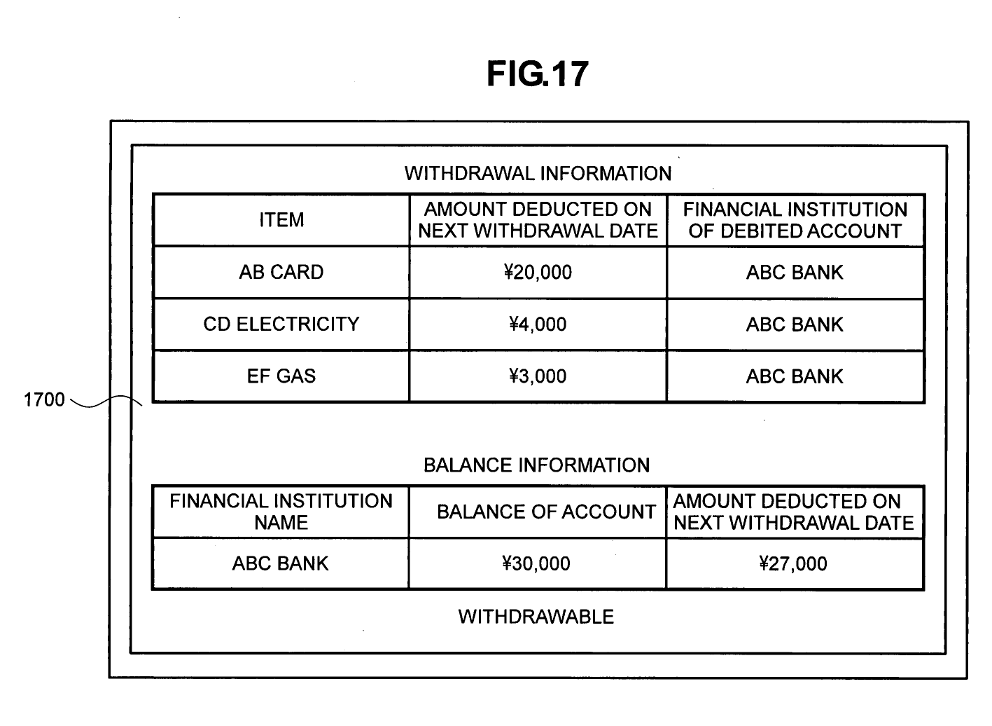

FIG. 16 shows a processing (S1600) for displaying the result of a comparison between a total amount to be withdrawn from an account and the current balance of that account, which is implemented where the item for withdrawal consists of a plurality of items and there takes place a plurality of withdrawals from a single account. The processing (S1600) is initiated by the mobile terminal 110 obtaining respective amounts of the withdrawals from the single account, by reference to tables shown in FIGS. 18 and 19 (S1610).

The plurality of items for withdrawal from the single account includes a withdrawal for a payment made by a credit card with using the mobile terminal 110, and for a payment made by automatic draft, such as electricity or gas bill payment. The mobile terminal 110 obtains the total amount of withdrawal from the nonvolatile memory portion 252, determines on the withdrawability by making a comparison between the total amount of withdrawal and the balance of the account as obtained from the balance information DB (S1620), and notifies the user of the result of the determination (S1630). The example 1700 of the screen display indicates, as information regarding withdrawals, items for withdrawal, amounts of withdrawals, financial institutions used for the withdrawals, for instance. The example 1700 of the display screen simultaneously indicates, as the balance information with respect to the financial institution used for the withdrawals, the balance of the debited account, the total amount currently debited to the account, and the result of the determination on the withdrawability made in step S1620.

In practice, it will be often the case that withdrawals for a plurality of items are made from a single account, and it is usual that automatic draft is used for various payments. Therefore, according to the arrangement of the present invention, not only the plurality of items for withdrawal and withdrawal amounts, but also the result of the comparison between the balance of the account from which the withdrawals for the items are made and the total amount to be withdrawn from the account, are displayed, as seen in the example 1800 of the screen display, so as to enhance the convenience of the user.

Although in the above description the IC card 280 stores various information regarding the credit card and debited account, such information may be stored in the nonvolatile memory portion 252. Further, although in the above description the information such as that regarding the payment amount and credit limit is stored in the nonvolatile memory portion 252, such information may be stored in the IC card 280. In the latter case, a mobile terminal 110 of a third party can be used in the same way as the user's own terminal 110, by inserting the IC card 280 ejected from the user's terminal, into the third party's. Thus, the portability is improved.

It is to be understood that the present invention is not limited to details of the embodiments described above each of which takes the form of a mobile terminal and has been described for illustrative purposes only. This invention is applicable to not only portable terminal devices such as mobile phone and PDA, but also non-portable terminal devices such as PC.

1. A communication terminal device capable of transmitting and receiving data, comprising:
a communication portion which transmits and receives data;
a display portion which displays information received by the communication portion; and
a control portion which controls the communication portion and the display portion,
wherein the communication portion receives card use information from a server of a card company and account information from a server of a financial institution, and
wherein the control portion operates to display the card use information and the account information side-by-side on the display portion.

2. A communication terminal device capable of transmitting and receiving data, comprising:
a communication portion which transmits and receives data;
a display portion which displays information received by the communication portion; and
a control portion which controls the communication portion and the display portion,
wherein the communication portion receives card use information from a server of a card company and account information from a server of a financial institution, and
wherein the control portion operates to display on the display portion a result of a comparison made between the card use information and the account information.

3. The communication terminal device according to claim 1, further comprising a memory portion which stores the card use information and the account information, wherein the control portion reads the card use information and the account information from the memory portion and displays the card use information and the account information regarding the display portion.

4. The communication terminal device according to claim 1, further comprising a credit-limit setting portion which sets a limit to an amount paid by a credit card, wherein the control portion operates to display on the display portion a result of a comparison made between the limit and the card use information.

5. The communication terminal device according to claim 4,
wherein the card use information includes an amount which has been paid by the credit card to date, and
wherein the control portion operates to display on the display portion a fact that the amount which has been paid exceeds the limit by a predetermined proportion, when appropriate.

6. The communication terminal device according to claim 1, wherein the communication portion receives the card use information when a payment is made by a credit card.

7. The communication terminal device according to claim 1, wherein the communication portion periodically receives the card use information.

8. The communication terminal device according to claim 1, further comprising notifier portion which notifies the user of information related to the card use information and the account information.

9. The communication terminal device according to claim 8, wherein the notifier portion notifies the user of the information related to the card use information and the account information regarding the day before a withdrawal date on which the payment made by the credit card is deducted from the account.

10. The communication terminal device according to claim 8, wherein the notifier portion periodically notifies the user of the information related to the card use information and the account information.

11. The communication terminal device according to claim 8, wherein the notifier portion notifies the user of the information related to the card use information and the account information, by sound, light or vibration.

12. The communication terminal device according to claim 1, further comprising an IC card which stores an ID, which is necessary to access the server of the card company or to access the server of the financial institution.

13. The communication terminal device according to claim 1, wherein the user can select a card company to use from a plurality of card companies.

14. The communication terminal device according to claim 1,
wherein the communication portion receives information related to charges for electricity, gas or water, and
wherein the control portion operates to display on the display portion a result of comparison made between the charges for electricity, gas or water and the account information.

15. The communication terminal device according to claim 1,
wherein the communication portion receives withdrawal amount information from the server of each of a plurality of card companies and account balance information from the server of the financial institution, the withdrawal amount information being related to an amount withdrawn from the account for the payment made by the credit card issued from the each card company, and
wherein the control portion operates to display on the display portion a result of a comparison made between a total amount to be withdrawn and the account balance information.

16. A communication terminal device capable of transmitting and receiving data, comprising:
a communication portion which transmits and receives data;
a display portion which displays information received by the communication portion; and
a control portion which controls the communication portion and the display portion,
wherein the communication portion receives card use information from a server of a card company and account information from a server of a financial institution, and
wherein the control portion operates to display the card use information and the account information in a single screen on the display portion.

17. A method of notifying account information, comprising steps of:
receiving card use information from a server of a card company;
receiving account information from a server of a financial institution:
comparing the card use information to the account information; and
notifying the user of a result of the comparison made between the card use information and the account information.

18. A method according to claim 17, wherein the notifying step comprise displaying the result of the comparison.

19. The communication terminal device according to claim 1,
wherein the card use information is related to use of a credit card issued to a user of the communication terminal device from a card company,
wherein the account information is related to an account to which a payment made by the credit card is debited.
